(19) United States
(12) Patent Application Publication
(10) Pub. No.: US 2005/0174301 A1
(43) Pub. Date: Aug. 11, 2005

(54) Plasma display module

(76) Inventor: Sok-San Kim, Cheonan-si (KR)

Correspondence Address: Robert E. Bushnell, Suite 300, 1522 K Street, N.W., Washington, DC, 20005-1202, US

(21) Appl. No.: 11/016,733

(22) Filed: Dec. 21, 2004

(30) Foreign Application Priority Data
Feb. 10, 2004 (KR) 2004-8632

(51) Int. Cl. G09G 5/00

(52) U.S. Cl. 345/3.1

(57) ABSTRACT

A plasma display module includes a chassis base, a PDP where an image is displayed, an attach/detachment structure that enables a user attach/detach the PDP to and from the chassis base, and a circuit unit that drives the PDP mounted on a rear surface of the chassis base. The module can be easily disassembled and usability of the disassembled components is increased while strength of the module against bending and twisting is enhanced.

### CLAIM OF PRIORITY

This application makes reference to, incorporates the same herein, and claims all benefits accruing under 35 U.S.C. § 119 from an application for PLASMA DISPLAY MODULE earlier filed in the Korean Intellectual Property Office on 10 Feb. 2004 and there duly assigned Ser. No. 2004-8632.

### BACKGROUND OF THE INVENTION

1 Field of the Invention

The present invention relates to a plasma display module, and more particularly, to a plasma display module that can be easily disassembled without damaging the components while providing increased protection from bending and twisting of the display.

2. Description of the Related Art

Plasma display modules are flat panels that display images by using a discharge effect. Because of their very good performance characteristics, such as high display capacity, high brightness, high contrast, clear latent images, and wide viewing angles, along with slim thickness and large screen size, the plasma display devices are considered to be the next generation display devices which will replace cathode ray tubes (CRTs).

In plasma display modules, it is difficult or impossible to disassemble the module. Typically, disassembly must be accomplished under austere working conditions such as high temperatures. Further, such disassembly is labor intensive, and produces low yield, as most parts of the module cannot be successfully recovered. If one or more components cannot be recovered, they must be discarded. This too can be problematical as such discarded components are environmentally unfriendly. Thus, what is needed is a plasma display module that is easy to disassemble.

### SUMMARY OF THE INVENTION

It is therefore an object of the present invention to provide an improved structure for a plasma display module.

It is also an object of the present invention to provide a plasma display module that can be easily disassembled so that the disassembled components can be easily reused.

It is further an object of the present invention to provide a plasma display module having an improved structure that can increase strength against bending and twisting.

It is yet another object of the present invention to provide a plasma display module that can effectively protect the display panel and wire connections.

It is still an object of the present invention to provide for a design that is safe and easy to disassemble while preventing the display from being bent or twisted.

It is yet another object of the present invention to provide for a design that is safe and easy to disassemble while protecting the edges of the display and protecting the wiring near the edges of the display.

These and other objects can be achieved by a plasma display module having a chassis base, a PDP on which an image is displayed, an attach/detachment structure that enables a user attach and detach the PDP to the chassis base and a circuit unit mounted on a rear surface of the chassis base to drive the PDP.

The attach/detachment structure may be attached to the chassis base by a mechanical combining element. The attach/detachment structure may be equipped on a side edge of the PDP. The attach/detachment structure can include a first combining unit connected to the PDP and a second combining unit extending perpendicular to the first combining unit and connected to the chassis base. The first combining unit may be attached to the PDP by an adhesive element and the second combining unit may be attached to the chassis base by a mechanical combining element such as a screw. The first combining unit, located between the PDP and the chassis base, can be attached to a rear surface of the PDP or can be attached to a front surface of the PDP.

The second combining unit can be attached to the bending unit of the chassis base. The second combining unit can be attached to the chassis base by a screw or can be hooked to the chassis base. The plasma display module can further include guide pins on the chassis base and hook holes corresponding to the guide pins on the second combining unit. The first combining unit and the second combining unit can be attached by a hinge structure.

The attach/detachment structure can include a frame unit that covers a side of the PDP, a first combining unit extending perpendicular to the frame unit and attached to the PDP, and a second combining unit extending perpendicular to the frame unit and attached to the chassis base. In this case, the first combining unit may be attached to the PDP by an adhesive element, and the second combining unit may be attached to the chassis base by a mechanical unit.

The first combining unit, located between the PDP and the chassis base, can be attached to a rear surface of the PDP or a front surface of the PDP. The second combining unit can be attached to the chassis base by a screw or can be hooked to the chassis base. When the second combining unit is attached by hooks, the plasma display module can further include guide pins on the chassis base and hook holes corresponding to the guide pins on the second combining unit. The second combining unit and the frame unit may be attached by a hinge structure. The attach/detachment structures can be separately attached to edges of the PDP or can cover at least two edge regions of the PDP.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating a plasma display panel and a chassis base in an attached state;

FIG. 2 is a perspective view illustrating the chassis base of FIG. 1;

FIG. 3 is an exploded perspective view illustrating a plasma display module according to a first embodiment of the present invention;

FIG. 4 is a cross-sectional view illustrating the plasma display module of FIG. 3;

FIGS. 5 and 6 are cross-sectional views illustrating first and second modified versions of the plasma display module of the first embodiment of the present invention;

FIG. 7 is an exploded perspective view illustrating a plasma display module according to a second embodiment of the present invention;

FIG. 8 is a cross-sectional view illustrating the plasma display module of FIG. 7;

FIG. 9 is a cross-sectional view illustrating a modified version of the plasma display module of the second embodiment of the present invention;

FIG. 10 is an exploded perspective view illustrating a plasma display module according to a third embodiment of the present invention;

FIG. 11 is a cross-sectional view illustrating the plasma display module of FIG. 10;

FIG. 12 is an exploded perspective view illustrating a plasma display module according to a fourth embodiment of the present invention;

FIG. 13 is a cross-sectional view illustrating the plasma display module of FIG. 12;

FIGS. 14 and 15 are cross-sectional views illustrating first and second modified versions of the plasma display module of the fourth embodiment of the present invention;

FIG. 16 is an exploded perspective view illustrating a plasma display module according to a fifth embodiment of the present invention;

FIG. 17 is a cross-sectional view illustrating the plasma display module of FIG. 16;

FIG. 18 is a cross-sectional view illustrating a modified version of the plasma display module of the fifth embodiment of the present invention;

FIG. 19 is an exploded perspective view illustrating a plasma display module according to a sixth embodiment of the present invention;

FIG. 20 is a cross-sectional view illustrating the plasma display module of FIG. 19;

FIG. 21 is an exploded perspective view illustrating a plasma display module according to a seventh embodiment of the present invention; and

FIG. 22 is a cross-sectional view illustrating the plasma display module of FIG. 21.

### DETAILED DESCRIPTION OF THE INVENTION

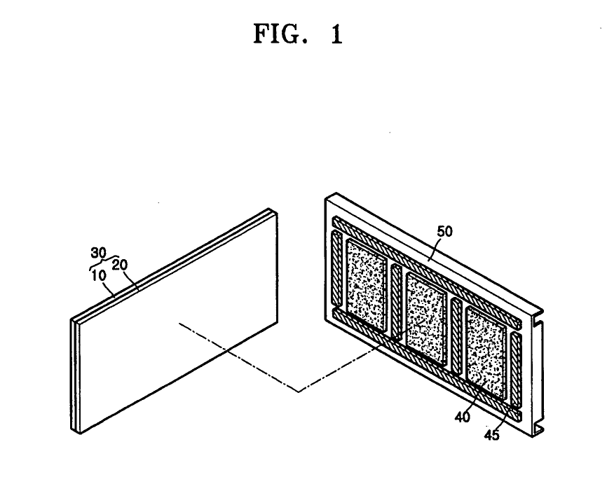

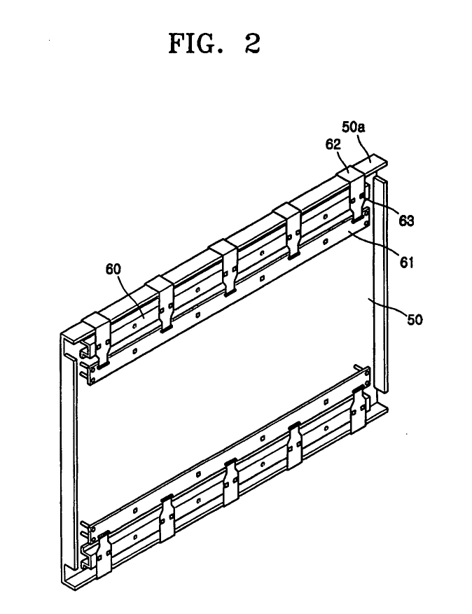

Turning now to the figures, FIG. 1 is a perspective view illustrating a plasma display panel (PDP) 30 and a chassis base in an attached state. Referring to FIG. 1, a PDP 30 includes a first panel 10 and a second panel 20 that is attached to the first panel 10. The PDP 30 is attached to a chassis base 50 using a double-sided tape 45, and a heat dissipating sheet 40 is located between the PDP 30 and the chassis base 50. The chassis base 50 is made of a material having a high thermal conductivity, such as aluminum, and serves as a heat dissipating plate for the PDP 30. The chassis base 50 also serves as a supporting unit for the PDP 30. Therefore, as depicted in FIG. 2, a bending unit 50a is formed on a side of the chassis base 50 and a reinforcing member 60 is added for reinforcing the strength of the chassis base 50.

Referring to FIG. 2, a circuit unit for driving the PDP 30 is attached to a rear surface of the chassis base 50. The circuit unit includes a printed circuit board 61 on which a driving device 63 and a plurality of circuit devices (not illustrated) are mounted. The circuit unit supplies power and a driving signal to the PDP 30 through wires 62. The chassis base 50 and the PDP 30 need to be taken apart when there is any defect on the chassis base 50, the driving device 63 or the wires 62 attached to the rear surface of the chassis base 50. Disassembly allows the PDP 30 to be reused as the PDP 30 is relatively expensive.

During disassembly, the removal of the double-sided tape 45 requires heating the display module to over 250° C. and manually separating the chassis base 50 from the PDP 30 by inserting a spatula. The disassembly has to be performed under poor working conditions, such as high temperatures. Also, the partially removed heat dissipating sheet 40 remains attached because of the high adhesiveness of the double-sided tape 45. Therefore, each of the remaining portions of the double-sided tape 45 or the heat dissipating sheet 40 has to be removed manually from the PDP 30, which is both labor intensive and often results in a damaged PDP 30.

Possibly damaged components, such as the chassis base 50, the double-sided tape 45, and the heat dissipating sheet 40, have to be discarded as industrial wastes. Recently, due to the problem of increasing industrial wastes, there is a trend to restrict imports of goods that cannot be disassembled. Therefore, a solution to the disassembling problem of the display module is increasingly important.

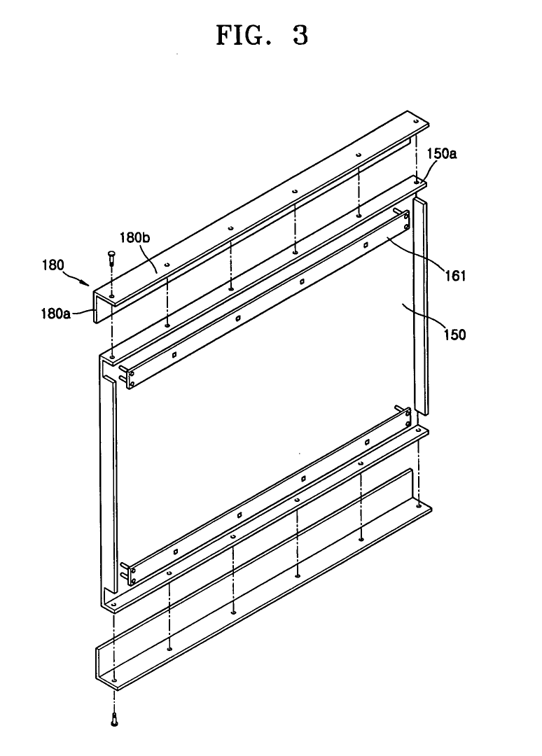

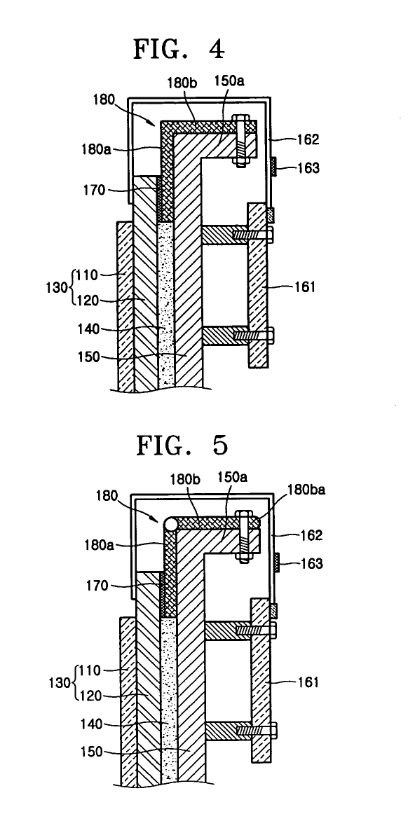

Turning now to FIGS. 3 and 4, FIG. 3 is an exploded perspective view illustrating a plasma display module according to a first embodiment of the present invention and FIG. 4 is a cross-sectional view illustrating the plasma display module of FIG. 3., For convenience of explanation, in FIG. 3, wires and driving devices mounted on the plasma display module are omitted.

Referring to FIG. 4, a plasma display module includes a PDP 130 on which an image is displayed, a chassis base 150, and a heat dissipating sheet 140 located between the PDP 130 and the chassis base 150. The PDP 130 is an image display unit on which images are displayed by the use of a discharge effect. The PDP 130 includes a first panel 110 and a second panel 120.

Since the PDP 130 generates heat during operation, the heat dissipation of the PDP 130 is accelerated by mounting the chassis base 150 on a rear surface of the PDP 130. For this purpose, the chassis base 150 can be formed of a material having a high thermal conductivity, such as aluminum. As depicted in FIG. 4, the chassis base 150 also serves as a supporting member for the PDP 130. Chassis base 150 can include a bending unit 150a for strength reinforcement. The chassis base 150 can be formed by a press processing.

The heat dissipating sheet 140 is located between the PDP 130 and the chassis base 150. The plasma display module according to the present invention includes an additional attach/detachment structure 180. Therefore, the heat dissipating sheet 140 does not have to have adhesion. This lack of adhesion enables the heat dissipating sheet 140 to be completely and easily removed from the PDP 130 during disassembly. On a rear surface of the chassis base 150, a driving device 163 that applies a driving signal to the PDP 130, a printed circuit board 161, and a wires that connect the driving device 163 to the PDP 130 are mounted.

In the plasma display module described above, the attach/detachment structure 180 that enables the chassis base 150 to detach from the PDP 130 is included. Referring to FIG. 3, the attach/detachment structure 180 includes a first combining unit 180a and a second combining unit 180b. As illustrated in FIG. 4, by interposing the first combining unit 180a between the PDP 130 and the chassis base 150, the first combining unit 180a can be attached to the rear surface of the PDP 130 using an adhesive element 170 such as a double-sided tape. The second combining unit 180b extends perpendicularly from the first combining unit 180a, and can be attached to the bending unit 150a of the chassis base 150 by a mechanical combining element, such as screws. In FIG. 3, the attach/detachment structure 180 is illustrated as being on an upper side and a lower side of the plasma display module, but is not limited thereto.

The attach/detachment structure 180 attaches the chassis base 150 to the PDP 130 in a manner where the chassis base 150 can be readily detached. That is, by using the attach/detach structure 180 in the plasma display module of FIGS. 3 and 4, the plasma display module can be easily disassembled without damaging any of the components. When the attach/detachment structure 180 is used, the PDP 130 and the chassis base 150 can be separated from each other by removing the mechanical combining element, i.e., screws, of the second combining unit 180b. By designing the plasma display module as above, the disassembling can be quickly and easily performed in such a manner that allows for the reuse of the components, such as the chassis base 150, the heat dissipating sheet 140, and the adhesive element 170. Also, the disassembled PDP 130 does not require repairs since the components do not become damaged during disassembly. The attach/detachment structure 180 separates from the chassis base 150 while it is being attached to the PDP 130.

The attach/detachment structure 180 can also serve as a reinforcing member for the chassis base 150. More specifically, the PDP 130 can be effectively protected from the bending and twisting moment (force) of the panel display module since the attach/detachment structure 180 attached to the chassis base 150 increases a bending and twisting strength of the panel display module. Therefore, an additional supporting member for the chassis base 150 is unnecessary, thus reducing material costs. Especially, when strength is reinforced by the attach/detachment structure 180, a desired strength can be achieved by increasing a thickness of the attach/detachment structure 180, especially by increasing a thickness of the second combining unit 180b attached to the chassis base 150.

The attach/detachment structure 180 can be made of polypropylene, polyamide, phenol or epoxy. When the attach/detachment structure 180 is formed of a light weight resin with high strength, the removal or reduction of a reinforcing material is possible. Then, a lightweight display module can be manufactured.

FIG. 5 is a cross-sectional view illustrating a first modified version of the plasma display module of FIG. 4. Referring to FIG. 5, the attach/detachment structure 180 includes the first combining unit 180a and the second combining unit 180b. The first combining unit 180a is located between the PDP 130 and the chassis base 150 and is attached to a rear surface of the PDP 130 using an adhesive element 170. The second combining unit 180b is oriented substantially perpendicular to the first combining unit 180a such that it contacts the bending unit 150a of the chassis base 150 and is attached to the chassis base 150 via screws.

The first combining unit 180a and the second combining unit 180b can be attached by a hinge structure. When the first and second combining units 180a and 180b are hinged, regardless of the material of the attach/detachment structure 180, these two combining units can be bent to a right angle (90°). Also, since an outer end 180ba of the second combining unit 180b is rounded, the wires 162 extended to the printed circuit board 161 passing about the second combining unit 180b can be protected.

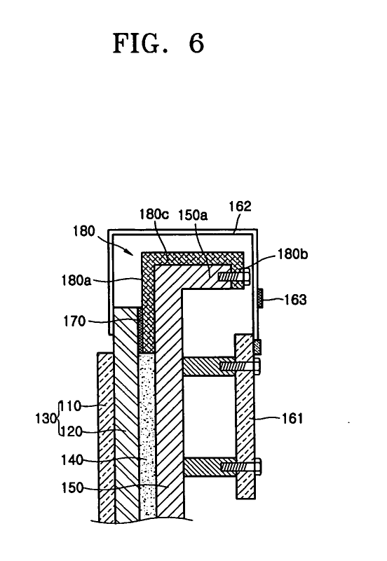

FIG. 6 is a cross-sectional view illustrating a second modified version of the plasma display module of FIG. 4. Referring to FIG. 6, the attach/detachment structure 180 includes the first combining unit 180a, the second combining unit 180b and a frame unit 180c. The first and second combining units 180a and 180b are extended approximately perpendicular to the frame unit 180c. The first combining unit 180a, which is located between the PDP 130 and the chassis base 150, is attached to a rear surface of the PDP 130 by the adhesive element 170, such as a double-sided tape, and the second combining unit 180b, which is connected to the end part of the chassis base 150, is attached to the chassis base. 150 by a mechanical combining element, such as screws. In this manner, since the attach/detachment structure 180 and the chassis base 150 are attached by a mechanical combining element, such as screws, the chassis base 150 and the PDP 130 can be readily disassembled by unscrewing the screw.

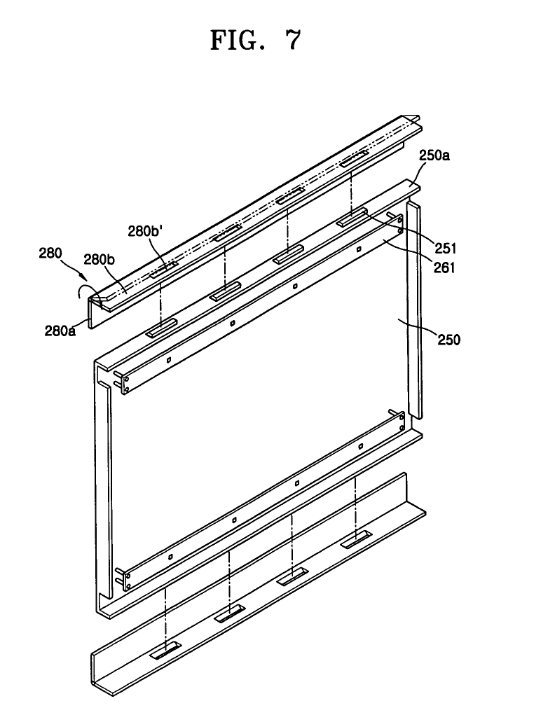

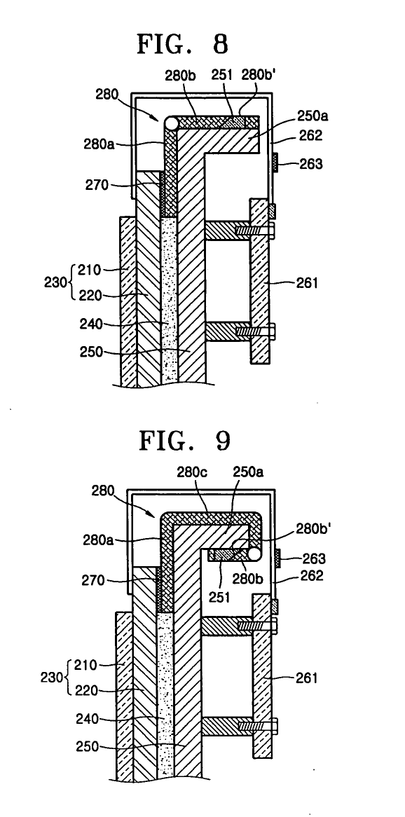

Turning now to FIGS. 7 and 8, FIG. 7 is an exploded perspective view illustrating a plasma display module according to a second embodiment of the present invention and FIG. 8 is a cross-sectional view illustrating the plasma display module of FIG. 7. Referring to FIG. 7, an attach/detachment structure 280 includes a first combining unit 280a and a second combining unit 280b. Here, the first combining unit 280a and the second combining unit 280b are attached by a hinge structure. Hook holes 280b′ perforate the second combining unit 280b, and guide pins 251 are formed on an upper part of a bending unit 250a. The attach/detachment structure 280 is hooked to the chassis base 250 by inserting the guide pins 251 through the hook holes 280b′ by rotating the second combining unit 280b.

Referring to FIG. 8, the first combining unit 280a, which is located between the PDP 230 and the chassis base 250, is attached to a rear surface of the PDP 230 by an adhesive element 270. In this manner, since the second combining unit 280b and the chassis base 250 are attached by hooking, that is, a mechanical combining element, they can be easily disassembled by rotating the hinged second combining unit 280b in reverse order. Mounting wires 262, a driving device 263, and a printed circuit board 261 are the same as in the first embodiment.

FIG. 9 is a cross-sectional view illustrating a modified version of the plasma display module of the second embodiment of the present invention. Referring to FIG. 9, the attach/detachment structure 280 includes first and second combining units 280a and 280b and a frame unit 280c. The frame unit 280c is formed to cover the bending unit 250a of the chassis base 250. The first and second combining units 280a and 280b are extended approximately perpendicular to the frame unit 280c. The second combining unit 280b is attached to the frame unit 280c by a hinge structure. Here, the first combining unit 280a, which is located between the PDP 230 and the chassis base 250, is attached to a rear surface of the PDP 230 by the adhesive element 270. Also, the second combining unit 280b, through which the hook holes 280b′ are formed, is hooked to the guide pins 251 formed on a lower surface of the bending unit 250a.

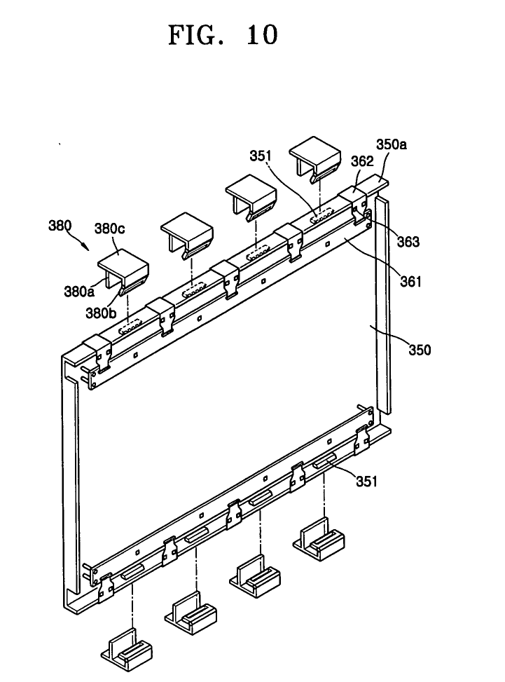

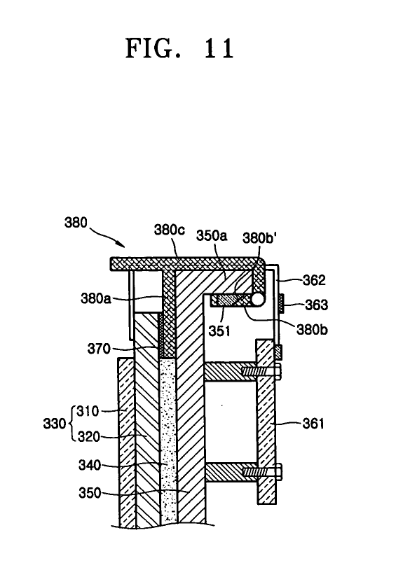

Turning now to FIGS. 10 and 11, FIG. 10 is an exploded perspective view illustrating a plasma display module according to a third embodiment of the present invention, and FIG. 11 is a cross-sectional view illustrating the plasma display module of FIG. 10. Referring to FIGS. 10 and 11, an attach/detachment structure 380 is mounted on an upper part and a lower part of a chassis base 350. Here, the attach/detachment structure 380 includes a plurality of sub components, and located between a PDP 330 and wires 362 that connect a printed circuit board 361 spaced at equal distances. The attach/detachment structure 380 includes a first combining unit 380a, that extends from a frame unit 380c and is approximately perpendicular to the frame unit 380c, and a second combining unit 380b. Here, the first combining unit 380a, which is located between the PDP 330 and the chassis base 350, is attached to a rear surface of the PDP 330 by an adhesive element 370, such as a double-sided tape. Also, the second combining unit 380b is hingedly attached to the frame unit 380c and hooked to guide pins 351 formed on a lower surface of a bending unit 350a. The frame unit 380c extends above the PDP 330 to effectively protect edge regions of the PDP 330 from external impacts, which may occur when moving the module. Mounting wires 362, a driving device 363, and a printed circuit board 361 are the same as in the first embodiment.

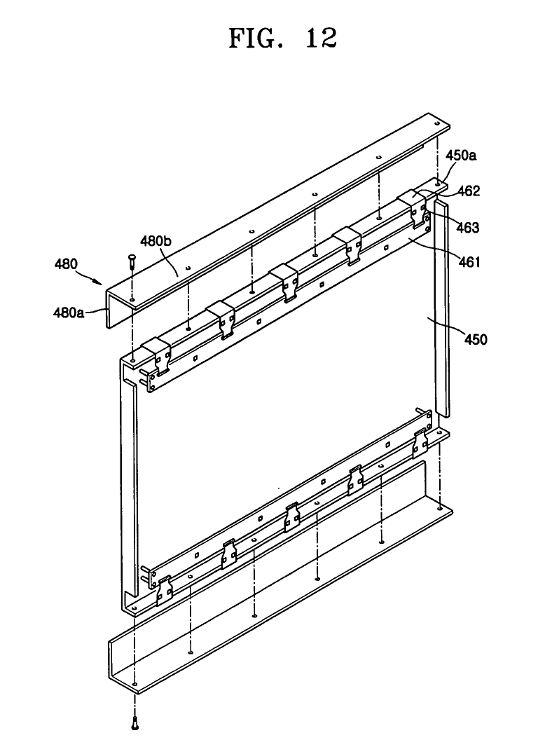

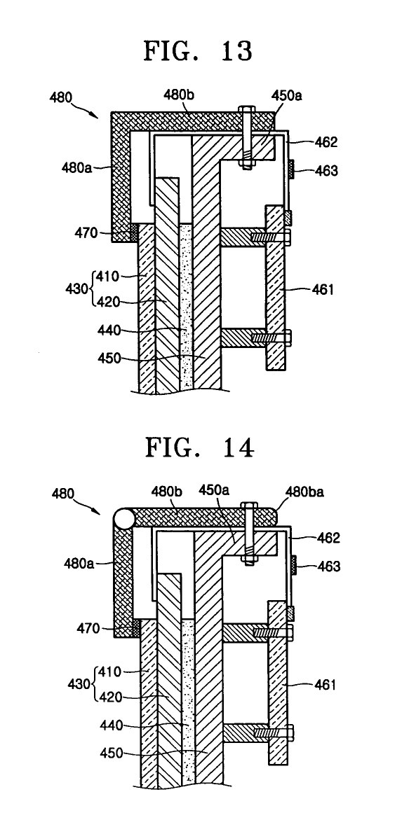

Turning now to FIGS. 12 and 13, FIG. 12 is an exploded perspective view illustrating a plasma display module according to a fourth embodiment of the present invention and FIG. 13 is a cross-sectional view illustrating the plasma display module of FIG. 12. Referring to FIGS. 12 and 13, an attach/detachment structure 480 includes a first combining unit 480a and a second combining unit 480b. The first combining unit 480a is attached to a front surface of a PDP 430 by an adhesive element 470. The second combining unit 480b extends approximately perpendicular to the first combining unit 480a to a bending unit 450a of a chassis base 450, and is attached to the bending unit 450a by a screw. Here, the second combining unit 480b can protect the edge region of the PDP 430 since it covers an upper edge part of the PDP 430 and the chassis base 450. Mounting wires 462, a driving device 463, and a printed circuit board 461 are the same as in the first embodiment.

Turning now to FIG. 14, FIG. 14 is a cross-sectional view illustrating a first modified version of the plasma display module of the fourth embodiment of the present invention. Referring to FIG. 14, the first combining unit 480a and the second combining unit 480b can be attached by a hinge. At this time, the first and second combining units 480a and 480b can be formed perpendicular to each other regardless of the material of the attach/detachment structure 480. Also, the wires 462 located between the second combining unit 480b and the chassis base 450 can be protected from impact by rounding an outer edge 480ba of the second combining unit 480b.

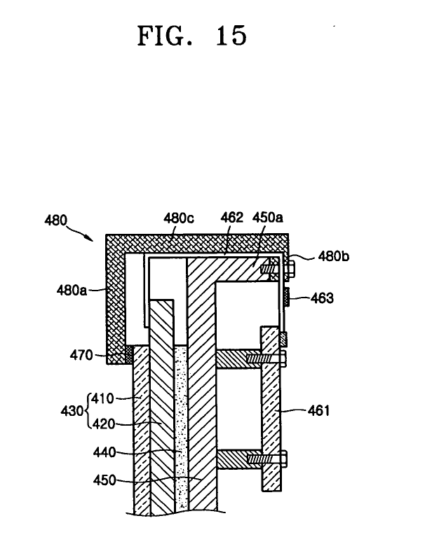

FIG. 15 is a cross-sectional view illustrating a second modified version of the plasma display module of the fourth embodiment of the present invention. Referring to FIG. 15, the attach/detachment structure 480 includes the frame unit 480c that covers an edge of the PDP 430 and the first and second combining units 480a and 480b that are bent at the frame unit 480c. The first combining unit 480a is attached to the PDP 430 by the adhesive element 470 and the second combining unit 480b is attached to the chassis base 450 by a mechanical combining element. Here, the second combining unit 480b is attached to the bending unit 450a of the chassis base 450 by a screw.

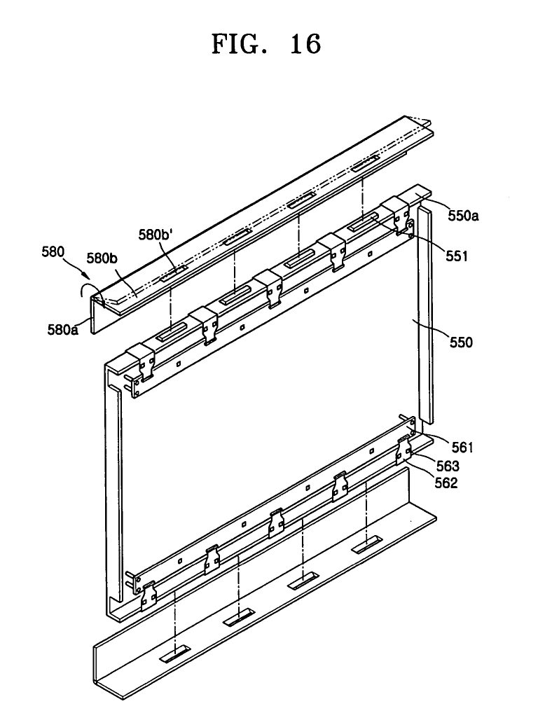

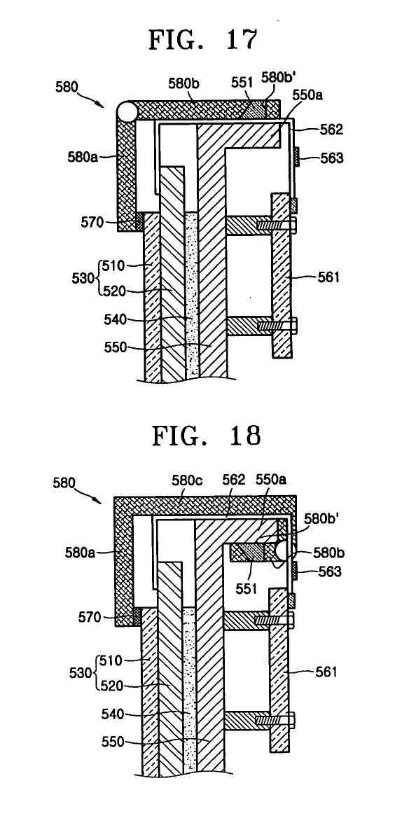

Turning now to FIGS. 16 and 17, FIG. 16 is an exploded perspective view illustrating a is plasma display module according to a fifth embodiment of the present invention and FIG. 17 is a cross-sectional view illustrating the plasma display module of FIG. 16. Referring to FIG. 16, an attach/detachment structure 580 includes a first combining unit 580a and a second combining unit 580b, that are attached by a hinge. Hook holes 580b′ perforate the second combining unit 580b and guide pins 551, corresponding to the hook holes 580b′, are formed on a bending unit 550a of a chassis base 550.

Referring to FIG. 17, the first combining unit 580a is attached to a front surface of a PDP 530 by an adhesive element 570, and the second combining unit 580b is hooked by inserting the guide pins 551 into hook holes 580b′ by rotating the hinged second combining unit 580b. Mounting wires 562, a driving device 563 and a printed circuit board 561 are the same as in the first embodiment.

FIG. 18 is a cross-sectional view illustrating a modified version of the plasma display module of the fifth embodiment of the present invention. Referring to FIG. 18, the attach/detachment structure 580 includes a frame unit 580c, a first combining unit 580a bent at the frame unit 580c, and the second combining unit 580b that is hinged to the frame unit 580c. Here, the first combining unit 580a is attached to a front surface of the PDP 530 by the adhesive element 570, and the hook holes 580b′ that perforate the second combining unit 580b are hooked on to the guide pins 551 formed on a lower surface of the bending unit 550a of the chassis base 550. Here, the hooking of the hook holes 580b′ of the second combining unit 580b to the guide pins 551 is achieved on a lower surface of the bending unit 550a.

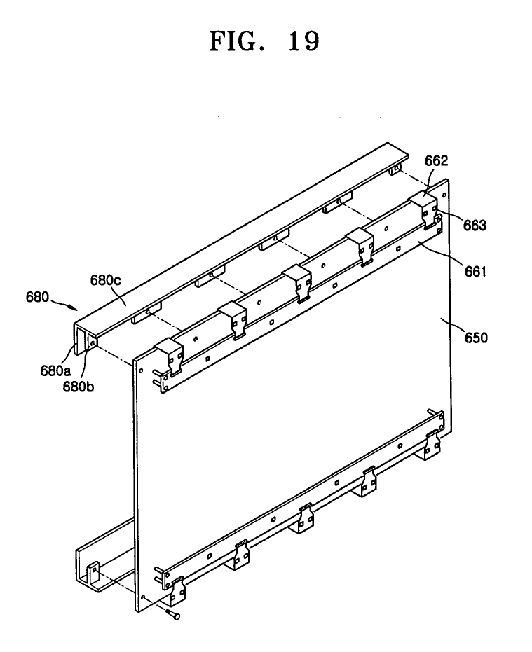

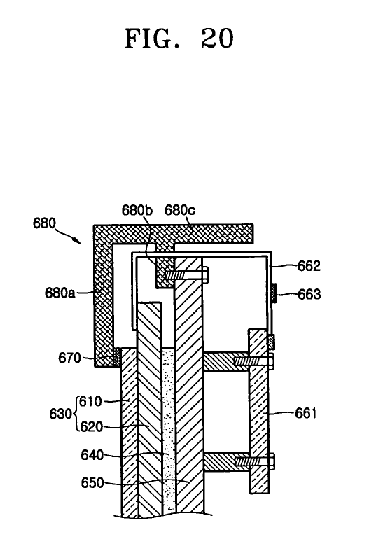

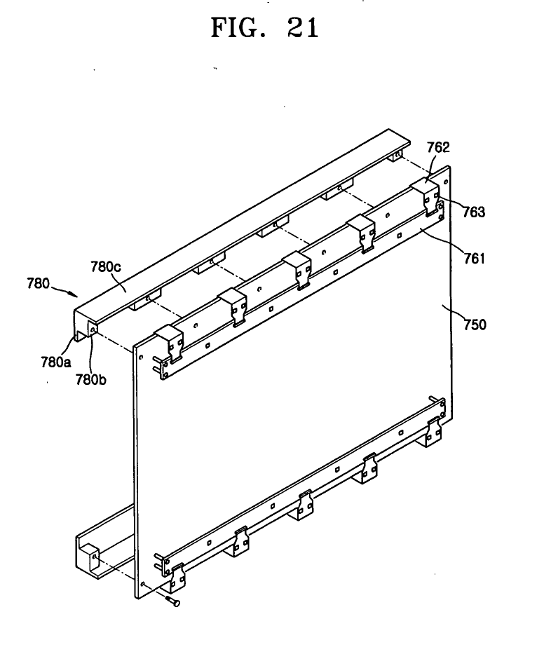

Turning now to FIGS. 19 and 20, FIG. 19 is an exploded perspective view illustrating a plasma display module according to a sixth embodiment of the present invention and FIG. 20 is a cross-sectional view illustrating the plasma display module of FIG. 19. Referring to FIG. 19, attach/detachment structures 680 attach to upper and lower edge portions of the plasma display module. The attach/detachment structure 680 includes a frame unit 680c, a first combining unit 680a bent approximately perpendicular to the frame unit 680c, and a second combining unit 680b. Here, wires 662 that connect the PDP 630 and the printed circuit board 661 can freely pass under the frame unit 680c since the second combining units 680b are formed in gaps between the wires 662.

Referring to FIG. 20, the first combining unit 680a is attached to a front surface of the PDP 630 by an adhesive element 670 such as a double-sided tape, and the second combining unit 680b is fixed to a chassis base 650 by a mechanical combining element such as screws. In FIG. 19, the attach/detachment structure 680 is attached to the upper and the lower edges of the plasma display module, but the present invention is in no way so limited. Mounting of a driving device 663 and a printed circuit board 661 are the same as in the first embodiment.

As depicted in FIG. 19, when sufficient strength reinforcement can be achieved by the attach/detachment structure 680, there is no need for a bending unit 650a on the chassis base 650, thus simplifying manufacturing processes and reducing costs. In this case, a thickness of the frame unit 680c extending toward the chassis base 650 and bent from the second combining unit 680b can be increased for further strength reinforcement. Mounting the wire 662, the driving device 663, and the printed circuit board 661 are the same as in the first embodiment.

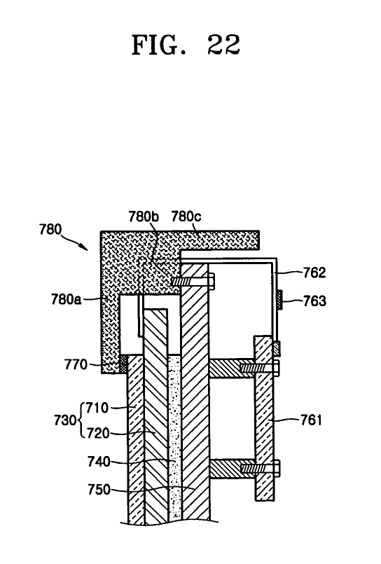

Turning now to FIGS. 21 and 22, FIG. 21 is an exploded perspective view illustrating a plasma display module according to a seventh embodiment of the present invention and FIG. 22 is a cross-sectional view illustrating the plasma display module of FIG. 21. Referring to FIG. 21, an attach/detachment structure 780 is attached to upper and lower edge regions of the plasma display module. The attach/detachment structure 780 includes a frame unit 780c, a first combining unit 780a bent at the frame unit 780c, and a second combining unit 780b, that has a step difference with respect to the frame unit 780c. Here, wires 762 that connect the PDP 730 to the printed-circuit board 761 can freely pass under the frame unit 780c since the second combining units 780b are formed in gaps between the wires 762.

Referring to FIG. 22, the first combining unit 780a is attached to a front surface of the PDP 730 by an adhesive element 770, such as a double-sided tape, and the second combining unit 780b is attached to a chassis base 750 by a mechanical combining element such as screws. When the plasma display module uses the attach/detachment structure 780, the PDP 730 and the chassis base 750 can be readily disassembled and a sufficient strength can also be achieved with the advantage of the strength reinforcement of the attach/detachment structure 780 without an additional reinforcing member or a bending unit.

In the reference drawings of the embodiments of the present invention, the attach/detachment structures are formed in multiple numbers and separately attached to each edge region of the plasma display module, but they are not limited thereto. The attach/detachment structure attached along more than two adjacent edge regions can be attached by forming a single body. Therefore, it is understood to those skilled in the art that in this case also the scope of the present invention can be equally applied.

The plasma display modules according to the present invention as above descriptions have following advantages. First, the disassembling of the plasma display module is easy and the reusability of the disassembled components is improved. According to the present invention, the disassembling of a module can be achieved by simply releasing the mechanical combining element since an attach/detachment structure and a chassis base are mechanically attached. Therefore, the disassembling workability is remarkably improved. Also, the components, such as the chassis base, the heat dissipating sheet, and the double-sided tape can be reused since the components can be disassembled with a low risk of being damaged. Also, efforts for repairing the PDP can be eliminated since a possibility of damage during disassembling of the PDP can be greatly reduced.

Second, sufficient strength against bending and twisting can be secured. According to the present invention, since the attach/detachment structure is attached to an edge region of the module, both a bending and a twisting strength of the module are sufficiently secured. Therefore, a reinforcing member for reinforcing the module mounted on the chassis base can be reduced or even eliminated. Furthermore, if a sufficient strength is attained, a bending unit formed on a side of the chassis base can be removed.

Third, edge regions of the PDP can be effectively protected. According to the present invention, since a portion of the attach/detachment structure is formed to cover an edge region of the PDP, the edge regions of the PDP can be protected from an impact that occurs while moving or transporting the module.

Fourth, the wires can be protected from damage. According to the present invention, a wiring can be protected from a cut-surface of the chassis base since wires connecting the PDP and driving devices are located along the attach/detachment structure.

While the present invention has been particularly illustrated and described with reference to exemplary embodiments thereof, it will be understood by those of ordinary skill in the art that various changes in form and details maybe made therein without departing from the spirit and scope of the present invention as defined by the following claims.

1. A plasma display module, comprising:
a chassis base;
a PDP adapted to display an image;
an attach/detachment structure adapted to allow for attachment and detachment of the chassis base to the PDP; and
a circuit unit mounted on a rear surface of the chassis base and adapted to drive the PDP.

2. The plasma display module of claim 1, the attach/detachment structure being attached to the chassis base by a mechanical combining element.

3. The plasma display module of claim 1, the attach/detachment structure being attached to an edge region of the PDP.

4. The plasma display module of claim 1, the attach/detachment structure comprises:
a first combining unit attached to the PDP; and
a second combining unit extending perpendicular to the first combining unit and attached to the chassis base.

5. The plasma display module of claim 4, the first combining unit being attached to the PDP by an adhesive element and the second combining unit being attached to the chassis base by a mechanical combining element.

6. The plasma display module of claim 4, the first combining unit being arranged between the PDP and the chassis base, the first combining unit being fixed on a rear surface of the PDP.

7. The plasma display module of claim 4, the first combining unit being attached to a front surface of the PDP.

8. The plasma display module of claim 4, the chassis base comprises a bending unit, the second combining unit being attached to the bending unit of the chassis base.

9. The plasma display module of claim 4, the second combining unit being fixed to the chassis base by a screw.

10. The plasma display module of claim 4, the second combining unit being hooked to the chassis base.

11. The plasma display module of claim 10, further comprising guide pins arranged on the chassis base, the second combining unit being perforated by hook holes that correspond to the guide pins on the chassis base.

12. The plasma display module of claim 10, the first combining unit and the second combining unit being connected by a hinge structure.

13. The plasma display module of claim 1, the attach/detachment structure comprises:
a frame unit that covers a side of the PDP;
a first combining unit extending perpendicular to the frame unit and attached to the PDP; and
a second combining unit extending perpendicular to the frame unit and attached to the chassis base.

14. The plasma display module of claim 13, the first combining unit being attached to the PDP by an adhesive element, the second combining unit being attached to the chassis base by a mechanical combining element.

15. The plasma display module of claim 13, the first combining unit being arranged between the PDP and the chassis base, the first combining unit being attached to a rear surface of the PDP.

16. The plasma display module of claim 13, the first combining unit being attached to a front surface of the PDP.

17. The plasma display module of claim 13, the second combining unit being attached to the chassis base by a screw.

18. The plasma display module of claim 13, the second combining unit being hooked to the chassis base.

19. The plasma display module of claim 18, further comprising guide pins arranged on the chassis base, the second combining unit being perforated by hook holes that correspond to the guide pins on the chassis base.

20. The plasma display module of claim 18, the second combining unit and the frame unit being attached by a hinge structure.

21. The plasma display module of claim 1, the attach/detachment structure being separately attached to an edge regions of the PDP.

22. The plasma display module of claim 1, the attach/detachment structure being attached along more than two adjacent edge regions of the PDP.
